(19) United States
(12) Patent Application Publication
(10) Pub. No.: US 2011/0148721 A1
(43) Pub. Date: Jun. 23, 2011

(54) COLUMN-ANTENNA FOR ELECTRONIC SURVEILLANCE SYSTEMS FOR CONSUMER GOODS

(76) Inventor: Fernando Javier Mengoni, Buenos Aires (AR)

(21) Appl. No.: 12/888,628

(22) Filed: Sep. 23, 2010

(30) Foreign Application Priority Data
Dec. 18, 2009 (AR) 20090104998

(51) Int. Cl. H01Q 1/00

(52) U.S. Cl. 343/721

(57) ABSTRACT

A column-antenna for electronic surveillance systems for consumer goods, to be arranged adjacent near the entrance and/or exit of the sales store under control, where said column-antenna presents a frame within which at least a retention guide is accommodated that harbors at least a translucent panel, and said panel includes an exterior surface displaying advertising images, illuminated by at least a light source located in the internal edges of said frame.

### CROSS-REFERENCE TO RELATED APPLICATIONS

The present application claims priority to Argentina Patent Application No. 20090104998 filed on Dec. 18, 2009.

### TECHNICAL FIELD

The present invention is related to the field of devices used for surveillance in stores, particularly the present invention is related to the detector devices of labels arranged at the entrance and exit of the stores so as to detect products or articles that are being drawn from the store without being paid, and specifically the present invention is related to the column-antenna for the known electronic surveillance systems for consumer goods.

### BACKGROUND OF THE INVENTION

The electronic surveillance systems for consumer goods are well known in the art and are an important part of any retail sales store, and even retailers, of consumer goods and products of any kind but generally products of easily hiding among clothes of supposed customers that are kept and hidden for shoplifting purposes. These systems operate as auto-adhesive labels or those that may be otherwise fixed on or within the consumer goods to be controlled. When the customer acquires the product and pays for it at the cash desk, the label is deactivated by an employee so that when the customer leaves through the store door, which is flanked by a pair of columns of detector antennas between which the customer should pass, the label does not trigger an alarm off. If the label fixed to the article is not deactivated and the individual passes with this article through the above mentioned columns of antennas, the alarm will trigger off the store alert alarm.

There exist innumerable forms and buildings of columns of antennas of this kind, either in vertical and slender panels or in the form of arcs generally opposed to each other, in order to establish a forced way so that the customer should pass between a pair of columns of antenna. Even when variable forms and designs exist, none of them provides the building means for the columns-antennas to be used for a second application such as containing and transmitting visual information as for example advertising.

In virtue of the foregoing, it would be convenient to have a column-antenna building for those surveillance systems for consumer goods which besides operating as antenna would be useful as an advertising means.

### SUMMARY OF THE INVENTION

It is therefore the object of the present invention to provide a new column-antenna for electronic surveillance systems for consumer goods which operates as a detector antenna of control labels and that also provides an advertising mean of prominent location at any sales store as is the entrance and exit of the store.

It is even another object of the present invention to provide a column-antenna for electronic surveillance systems for consumer goods that includes a frame within which at least a retention guide, at least a translucent panel fixed to said at least one guide, and that said translucent panel presents an external surface displaying advertising images, to face said entrance and/or exit of the sales store.

It is still another object of the present invention to provide a column-antenna for electronic surveillance systems for consumer goods that includes within said frame, at least a light source that is adjacent to said translucent panel and to an internal surface of said panel, thus forming an advertising image illuminated by said light source.

It is even another object of the present invention to provide a column-antenna for electronic surveillance systems for consumer goods, the type that presents at least a frame within which the antenna is accommodated and that is arranged adjacent near the entrance and/or exit of the store under control, comprising the column-antenna at least a retention guide on said frame, at least a translucent panel that is fixed to said at least one retention guide, and having an external surface displaying advertising images, and at least a light source on said frame, adjacent to said translucent panel and to an internal surface of said panel opposed to said surface that faces said entrance and/or exit.

### DESCRIPTION OF THE DRAWINGS

For better understanding and clarity of the object of the present invention, it has been illustrated in various figures, where the invention has been represented in one of the preferred forms of embodiment, as an example, wherein:

FIG. 1 is a perspective view corresponding to the new column-antenna for electronic surveillance systems for consumer goods, according to a preferred embodiment of the present invention; and

FIG. 2 is a perspective and exploded view of the column-antenna for electronic surveillance systems for consumer goods, where at least a guide, at least a translucent panel and at least a light source adjacently arranged to said translucent panel and on said frame, are distinguished.

### DETAILED DESCRIPTION OF THE INVENTION

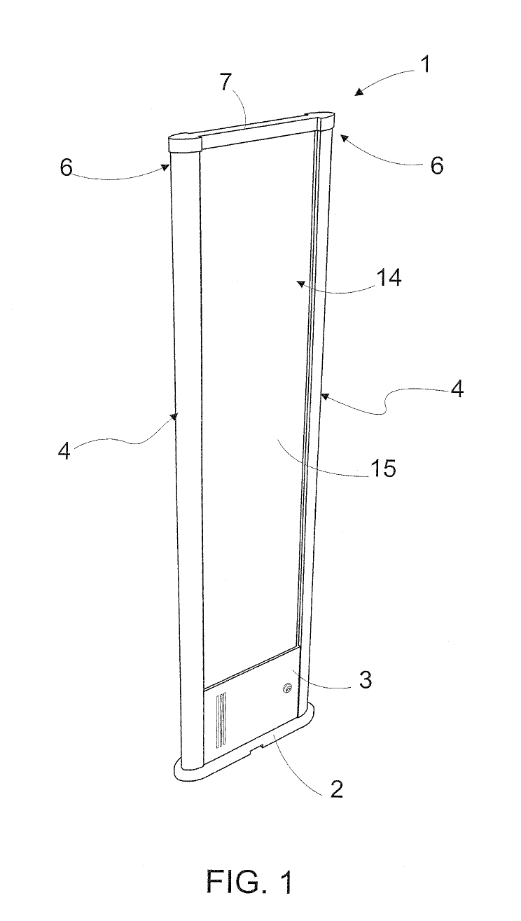

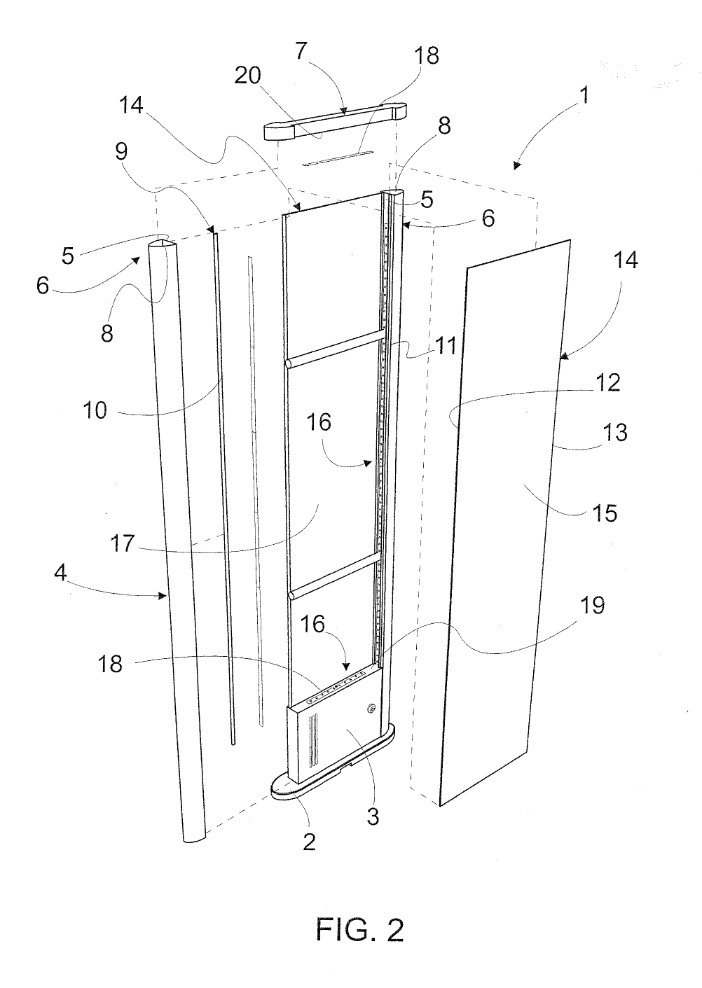

Now referring to FIGS. 1 and 2, it can be seen that the invention consists of a new column-antenna 1 for the known surveillance systems for consumer goods, which presents a base 2 with a module 3, where the electronic devices of the detector antenna of articles with a label to avoid shoplifting are accommodated. Said column-antenna is located or is preferably used at the entrance and/or exit of a store under control, that is to say the present column-antenna is located at both sides of said entrance and/or exit.

Today, there exist a variety of column-antennas used as detection means, so as to prevent shoplifting, and these devices are generally located at retail stores and/or wholesale stores, to prevent, as it was above mentioned, shoplifting. Said devices operate through the antenna that detects the labels that have not been deactivated after payment for the article.

That's why, knowing that in most retail and wholesale stores this means is used as surveillance device, the present invention provides the column-antenna 1 as an additional advertising mean, wherein said column-antenna 1 presents at least a frame 4, that is preferably closed and presents internal edges 5. Said frame, as it was above mentioned, is closed and may be formed by a removable tip 7 at the top 6 of said frame 4, and the tip 7 is fixed to two vertical portions 8 of said frame.

On the other side, on said internal edges of said frame 4, at least a retention guide 9 is fixed, preferably comprising a pair of rods 10 and 11 in a “U” form and opposed to each other. Said at least a frame and said pair of rods are of a material selected among, plastic, acrylic, glass fiber or the like. Said pair of rods 10 and 11, each harbors, within said both opposed “U”, opposed edges 12 and 13 of at least a translucent panel 14, which would preferably may be two translucent panels 14, of plastic material, polycarbonate, acrylic, etc.

Said at least a panel has an external surface 15, image display, such as for advertising, informative, decorative purposes, etc. In said external surface or said panel, a paper sheet, plastic or other material may be placed, that is useful for advertising or for bringing any other information as it was above mentioned. Said external surface 15 of said at least a translucent panel 14, is preferably arranged facing said entrance and/or exit of a store.

To attract even more people's attention, the present invention is provided with at least a light source 16, arranged within said frame 4, adjacent to said translucent panel and to an internal surface 17 of said at least panel, which is opposed to said external surface facing said entrance and/or exit of said store. Said at least a light source 16 comprises at least a carrier strip of a plurality of “leds” 18, which could be fixed to a remaining portion of the internal edges 5 of said frame 4, without taking the place of said pair of rods 10 and 11. That is, it will be provided with two strips of “leds” 18, facing each other in the internal edges 5 of the frame 4. Also said at least a carrier strip of a plurality of “leds” 18, will be arranged to increase the lightness of the column-antenna 1, over the superior surface 19 of module 3 and over an internal edge 20 of said removable tip 7. It is worth mentioning that the “leds” consume a less quantity of energy than the light sources conventionally used to illuminate the advertising signs. To the purposes of the present invention said carrier strip of said plurality of “leds” will vary its size or proportions being adapted for each zone of the frame where said strip is desirably arranged.

Said “leds” of said strips arranged in the present column-antenna 1, allow the sheet to be arranged in said at least a translucent panel 14, to be brilliantly displayed, in various colors, for example, if it is a logotype, a brand with different colors and other messages, thanks to the internal light being emitting by said “leds”, thus offering a column-antenna of the electronic surveillance system for consumer goods with advertising or informative purposes.

What is claimed is:

1. A column-antenna for electronic surveillance systems for consumer goods, of the type that presents at least a frame within which the antenna is accommodated and that is arranged adjacent near the entrance and/or exit of the store under control, being the column-antenna characterized by comprising:
at least a retention guide on said frame;
at least a translucent panel that is fixed to said at least a retention guide, and having an external surface displaying advertising images and facing the entrance and/or exit; and
at least a light source on said frame, adjacent to said translucent panel and to an internal surface of said panel opposed to said external surface that faces said entrance and/or exit.

2. A column-antenna according to claim 1, characterized by being said frame closed and presenting internal edges over which said at least a retention guide is fixed.

3. The column-antenna according to claim 1, characterized by comprising the superior part of said frame a tip removable fixed to two vertical portions of the frame.

4. The column-antenna according to claim 1, characterized by comprising said at least a retention guide a pair of rods facing each other in a “U” form and presenting said at least a panel opposed edges that are located within said “U” opposed to each other.

5. The column-antenna according to claim 1, characterized by comprising said light source at least a carrier strip of a plurality of “leds” fixed to an internal edge of the frame.

6. The column-antenna according to claim 1, characterized by providing two strips of “leds” facing each other in the internal edges of the frame.

7. The column-antenna according to claim 1, characterized by providing a strip of “leds” in an internal edge of said tip removable from said frame and another strip of “leds” over the superior surface of a container module of the electronic devices.

8. The column-antenna according to claim 1, characterized by being said at least a translucent panel of a material selected among, plastic, polycarbonate, acrylic among other translucent materials.

9. The column-antenna according to claim 5, characterized by providing two strips of “leds” facing each other in the internal edges of the frame.

10. The column-antenna according to claim 5, characterized by providing a strip of “leds” in an internal edge of said tip removable from said frame and another strip of “leds” over the superior surface of a container module of the electronic devices.
